(19) United States
(12) Patent Application Publication
(10) Pub. No.: US 2021/0287855 A1
(43) Pub. Date: Sep. 16, 2021

(54) CAPACITOR

(71) Applicant: Panasonic Intellectual Property Management Co., Ltd., Osaka (JP)

(72) Inventors: NAOHIRO KOSUGA, Shimane (JP); KEIJI MITSUDA, Shimane (JP)

(21) Appl. No.: 17/335,074

(22) Filed: Jun. 1, 2021

Related U.S. Application Data
(63) Continuation of application No. PCT/JP2019/037201, filed on Sep. 24, 2019.

(30) Foreign Application Priority Data
Dec. 25, 2018 (JP) 2018-241878

(51) Int. Cl. H01G 4/242; H01G 4/224; H02M 7/00; H01G 4/33

(52) U.S. Cl. CPC H01G 4/242; H01G 4/33; H02M 7/003; H01G 4/224

(57) ABSTRACT

A capacitor configured to be surface-mounted on a predetermined mounting surface, and includes a capacitor element including an electrode at each of both end faces of the capacitor element and a bus bar connected to the electrode. The bus bar includes a plurality of connection terminal portions that are arranged in a comb-teeth shape. At least one of the plurality of connection terminal portions is disposed on a connection portion disposed in the predetermined mounting surface and is electrically connected to the connection portion.

### RELATED APPLICATIONS

This application is a continuation of the PCT International Application No. PCT/JP2019/037201 filed on Sep. 24, 2019, which claims the benefit of foreign priority of Japanese patent application No. 2018-241878 filed on Dec. 25, 2018, the contents all of which are incorporated herein by reference.

### BACKGROUND

### 1. Technical Field

The present disclosure relates to a capacitor, and is particularly suitable for use in a surface-mount capacitor.

### 2. Description of the Related Art

An example of a surface-mount capacitor mounted on a mounting surface of a printed circuit board is described in, for example, Unexamined Japanese Patent Publication No. 2000-323352.

In the capacitor of Unexamined Japanese Patent Publication No. 2000-323352, electrode extraction portions (electrodes) are disposed at both winding ends (both end faces) of the metallized film capacitor element. A terminal fitting is connected to each of the electrode extraction portions. The terminal fitting has a terminal portion that is formed by bending a battledore-shaped metal plate and is soldered to a conductor of a printed circuit board. The metallized film capacitor element is housed in a case, and in this state, the upper surface of the terminal portion of the terminal fitting is located substantially in the same plane as an opening edge of the case.

In the above capacitor, the terminal portion of the terminal fitting has a plate shape and an area of the terminal portion is larger than that of a lead terminal, so that mounting strength to the printed circuit board by soldering become high.

### SUMMARY

The present disclosure relates to a capacitor configured to be surface-mounted on a predetermined mounting surface. The capacitor according to this aspect includes a capacitor element including an electrode at each of both end faces and a bus bar connected to the electrode. Here, the bus bar includes a plurality of connection terminal portions that are arranged in a comb-teeth shape. And at least one of the plurality of connection terminal portions is disposed on a connection portion disposed in the predetermined mounting surface, and is electrically connected to the connection portion.

According to the present disclosure, it is possible to provide a capacitor in which thermal damage of a capacitor element is suppressed to occur when surface mounting is performed. Here, surface mounting means, for example, a method whereas solder printing or the like is performed on a surface of a printed circuit board by a solder printing machine and then a electronic component is mounted on the printed circuit board by using a chip mounter, and after that, heat is applied in a reflow furnace to melt the solder and fix the electronic component to the printed circuit board.

Effects or meanings of the present disclosure are further clarified in the following description of an exemplary embodiment. However, the exemplary embodiment shown below is merely an example of implementing the present disclosure, and the present disclosure is not at all limited to the examples described in the following exemplary embodiment.

### BRIEF DESCRIPTION OF THE DRAWINGS

FIG. 1A is a perspective view illustrating a film capacitor according to an exemplary embodiment;

FIG. 1B is a cross-sectional view illustrating the film capacitor cut at a center in a front-rear direction according to the exemplary embodiment;

FIG. 2 is a perspective view illustrating a capacitor element to which a pair of bus bars is connected according to the exemplary embodiment;

FIG. 3A is a bottom view illustrating a case according to the exemplary embodiment;

FIG. 3B is a cross-sectional view taken along line A-A′ of FIG. 3A;

FIG. 4A is a perspective view showing how the film capacitor is surface-mounted on a mounting surface of a printed circuit board according to the exemplary embodiment;

FIG. 4B is a diagram showing a part of terminal connection portions and lands connected by solder according to the exemplary embodiment;

FIG. 5A is a perspective view illustrating a bus bar according to Modification 1;

FIG. 5B is a perspective view illustrating a bus bar according to Modification 1;

FIG. 6A is a perspective view illustrating a bus bar according to Modification 2; and

FIG. 6B is a cross-sectional view illustrating a film capacitor mounted on a mounting surface of a printed circuit board according to Modification 2.

### DETAILED DESCRIPTION OF EMBODIMENT

As in the case of the terminal fitting of the capacitor of Unexamined Japanese Patent Publication No. 2000-323352, when the terminal portion has a plate shape and the area of the mounting surface on the printed circuit board is increased, the volume of the terminal portion is increased accordingly.

A surface-mount capacitor can be mounted on a printed circuit board by reflow soldering. In this case, solder paste (cream solder) is applied to a conductor, which is, for example, a land, of the printed circuit board to which a terminal portion is connected, and the capacitor is placed on the printed circuit board such that the terminal portion is placed on the solder paste. After that, the printed circuit board on which the capacitor is placed is heated upto a high temperature in a reflow furnace. As a result, when the solder paste is melted and then the printed circuit board is cooled, the terminal portion and the land are fixed by solder.

As the volume of the terminal portion increases as in the above-mentioned capacitor, the heat capacity increases accordingly, so that the terminal portion does not easily reach a high temperature when heated in the reflow furnace, and the solder paste does not easily melt. As a result, the time required for soldering increases. In order to shorten the time required for soldering, it is necessary to raise the temperature inside the reflow furnace. In any of these cases, the capacitor is easily exposed to a high temperature, so that there is a concern about thermal damage to a capacitor element.

In view of such a problem, the present disclosure provides a capacitor in which thermal damage of a capacitor element is suppressed to occur when surface mounting is performed.

Film capacitor 1, which is an exemplary embodiment of a capacitor of the present disclosure, will be described below with reference to the drawings. For the sake of convenience, directions including front and rear, left and right, and up and down are added to the drawings as appropriate. The directions shown in the drawings are not absolute directions but relative directions in relation to an orientation of film capacitor 1. Further, for convenience of explanation, in some configurations, names such as “top surface portion” and “front side surface portion” may be given according to the directions shown in the drawings.

In the present exemplary embodiment, film capacitor 1 corresponds to a “capacitor” described in the claims In addition, land 23 corresponds to a “connection portion” described in the claims. Further, end face electrode 110 corresponds to an “electrode” described in the claims Further, protrusion 212 corresponds to a “first protrusion” described in the claims, and protruding piece 214 corresponds to a “second protrusion” described in the claims Further, filling resin 400 corresponds to an “exterior resin” described in the claims

However, the above description is only intended to define correspondences between components in the claims and components in the exemplary embodiment. The correspondences described above do not limit the scope of the disclosure in the claims to the configuration described in the exemplary embodiment.

Film capacitor 1 of the present exemplary embodiment can be surface-mounted on a mounting surface such as a printed circuit board, and can be used, for example, as one of electrical components of a vehicle such as an automobile.

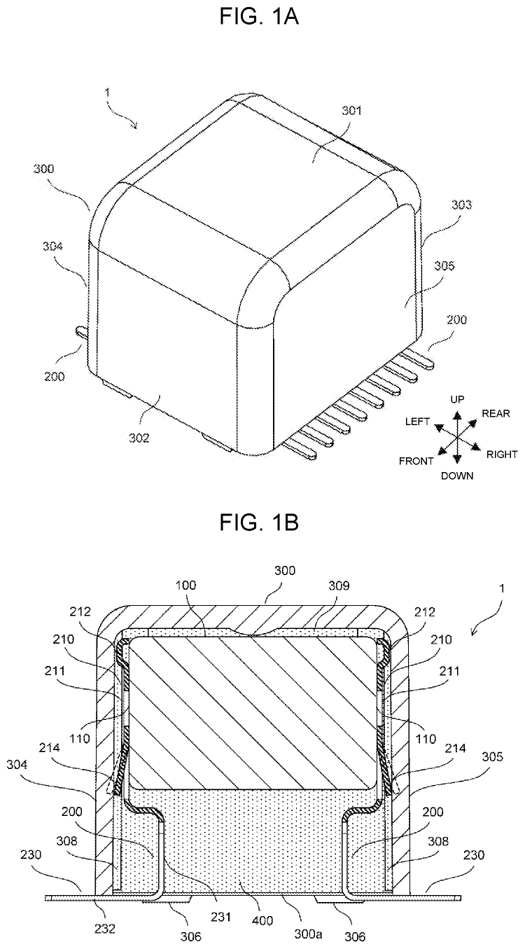

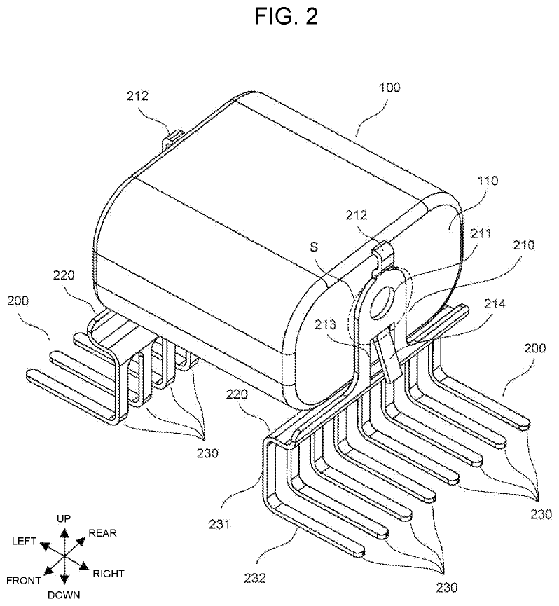

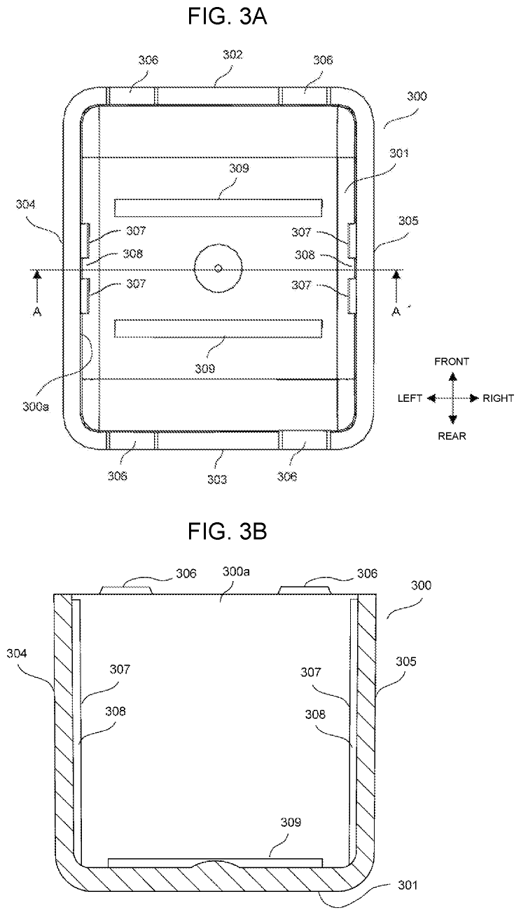

FIG. 1A is a perspective view illustrating film capacitor 1, and FIG. 1B illustrating a cross-sectional view of film capacitor 1 cut at a center in a front-rear direction. FIG. 2 is a perspective view illustrating capacitor element 100 to which a pair of bus bars 200 is connected. FIG. 3A is a bottom view illustrating case 300, and FIG. 3B is a sectional view taken along line A-A′ of FIG. 3A.

Film capacitor 1 includes capacitor element 100, the pair of bus bars 200, case 300, and filling resin 400. Capacitor element 100 to which the pair of bus bars 200 is connected is housed in case 300. Case 300 is filled with filling resin 400, and capacitor element 100 and a part of the pair of bus bars 200 are covered with filling resin 400.

Hereinafter, a detailed configuration of film capacitor 1 will be described.

Capacitor element 100 is formed by stacking of two metallized films in each of which aluminum is deposited on a dielectric film, winding or laminating of the stacked metallized films, and pressing of the wound or laminated metallized films into a flat shape. End face electrodes 110 are formed on left and right end faces of capacitor element 100 by spraying a metal such as zinc.

Each bus bar 200 is formed by appropriately cutting out and bending a conductive material, for example, a copper plate, and has a configuration in which electrode terminal portion 210, relay terminal portion 220, and eight external connection terminal portions 230 are integrated.

Electrode terminal portion 210 overlaps with end face electrode 110 of capacitor element 100. Electrode terminal portion 210 is long in a up-down direction and has an arc shape at an upper end. An upper portion of electrode terminal portion 210 has opening 211 having a circle shape concentric with the arc shape at the upper end. Further, protrusion 212 is provided at the upper end of electrode terminal portion 210. Protrusion 212 has a U-shape that is bent to protrude in a direction away from the end face (end face electrode 110) of capacitor element 100. Further, a lower portion of electrode terminal portion 210 has opening 213 having a rectangular shape. And protruding piece 214 having a rectangular shape is provided at an upper edge of opening 213. Protruding piece 214 extends downward and away from the end face of capacitor element 100. Protruding piece 214 has a property of leaf spring capable to deform in a direction approaching the end face of capacitor element 100. Protrusion 212 and protruding piece 214 have substantially same widths as a width of a groove of case 300 described later, and are aligned in a straight line in the up-down direction.

Relay terminal portion 220 has substantially a same width as a width in a longitudinal direction of the end face (end face electrode 110) of capacitor element 100. Relay terminal portion 220 extends slightly downward, and then is bent to extend inward of capacitor element 100. A middle portion of relay terminal portion 220 is connected to a lower end of electrode terminal portion 210.

Eight external connection terminal portions 230 are arranged, in the longitudinal direction (front-back direction) of the end face of capacitor element 100, to have a comb-teeth shape. Each of external connection terminal portions 230 has a substantially L-shape. And a cross section of external connection terminal portion 230 is formed to have a square shape. Each external connection terminal portion 230 includes intermediate terminal portion 231 and and connection terminal portion 232. Intermediate terminal portion 231 extends in a direction away from capacitor element 100 (downward) from a lower end of relay terminal portion 220. And connection terminal portion 232 is continuous with intermediate terminal portion 231 and extends in a direction intersecting (a direction orthogonal to) and away from the end face of capacitor element 100.

In bus bar 200, the upper portion of electrode terminal portion 210 is connected to end face electrode 110 of capacitor element 100 by solder S. As a result, bus bar 200 and end face electrode 110 are electrically connected. At this time, since the upper portion of electrode terminal portion 210 has opening 211, end face electrode 110 is joined by solder S not only in an outer peripheral edge portion of electrode terminal portion 210 but also in a peripheral edge portion of opening 211. Thus, bond between electrode terminal portion 210 and end face electrode 110 is strengthened.

Case 300 is made of resin, for example, polyphenylene sulfide (PPS). Case 300 has a substantially rectangular parallelepiped box shape, and includes top surface portion 301, front side surface portion 302, rear side surface portion 303, left side surface portion 304, and right side surface portion 305. And a bottom surface of case 300 is open. Each corner of case 300 has a curved surface shape. And in particular, a radius of curvature of each curved surface shape at a connection corner between top surface portion 301 and front side surface portion 302 and at a connection corner between top surface portion 301 and rear side surface portion 303 is larger than that at other connection corners.

Rectangular parallelepiped-shaped leg 306 is formed at each of two locations on left and right in a lower surface of each of front side surface portion 302 and rear side surface portion 303. Further, groove 308 extending in the up-down direction is formed on an inner wall surface of each of left side surface portion 304 and right side surface portion 305. Groove 308 is formed at a center in the front-rear direction of the inner wall surface, and formed by two ribs 307 extending in the up-down direction. In addition, two ribs 309 each extending in the left-right direction are formed on top surface portion 301. Two ribs 309 are respectively located at front position and back position of an inner wall surface.

When film capacitor 1 is assembled, capacitor element 100 in which bus bars 200 are connected to both end face electrodes 110 is housed in case 300 through opening 300a on the bottom surface of case 300 while each of capacitor element 100 and case 300 is turned upside down. At this time, in a state that capacitor element 100 is housed in case 300, capacitor element 100 is disposed at an orientation such that the two end faces (two end face electrodes 110) of capacitor element 100 respectively face the inner wall surface of left side surface portion 304 and the inner wall surface of right side surface portion 305 of case 300.

Capacitor element 100 is inserted into case 300 such that protrusion 212 and protruding piece 214 of bus bar 200 fit into groove 308 of case 300. At this time, since a tip of protruding piece 214 projects outward from the inner wall surface of case 300 (broken line in FIG. 1B), protruding piece 214 deforms inward to be put into grooves 308 as capacitor element 100 is inserted into case 300. When capacitor element 100 is completely housed in case 300, a peripheral surface of capacitor element 100 comes into contact with ribs 309 of top surface portion 301 of case 300. As a result, gaps for filling resin 400 to enter are secured between top surface portion 301 of case 300 and capacitor element 100. Further, since protrusion 212 and protruding piece 214 are fit into groove 308, it is held a state that bus bar 200 is not tilted with respect to case 300.

Filling resin 400 is filled inside case 300 in which capacitor element 100 is housed. Filling resin 400 is a thermosetting resin such as an epoxy resin and is injected into case 300 while being molten. At this time, protruding pieces 214 of left and right bus bars 200 are respectively pressed against the inner wall surfaces of left side surface portion 304 and right side surface portion 305 due to the leaf spring property of protruding pieces 214. Hence, capacitor element 100 is difficult to move in a direction toward an opening of case 300, and thus lifting of capacitor element 100 is suppressed when filling resin 400 is injected.

After that, filling resin 400 in case 300 is cured by heating the inside of case 300. Capacitor element 100 is covered with case 300 and filling resin 400, and protected from moisture and impact.

In this way, film capacitor 1 is completed as shown in FIG. 1A. As shown in FIG. 1B, in eight external connection terminal portions 230 of each of the pair of bus bars 200, intermediate terminal portions 231 are almost entirely buried inside filling resin 400, and tips of intermediate terminal portions 231 exposed from filling resin 400 are respectively connected to connection terminal portions 232. Each connection terminal portion 232 extends in a direction parallel to opening 300a of case 300 (left-right direction). In the direction parallel to opening 300a, about half of each connection terminal portion 232 at a tip end side protrudes (sticks out) to an outside of case 300.

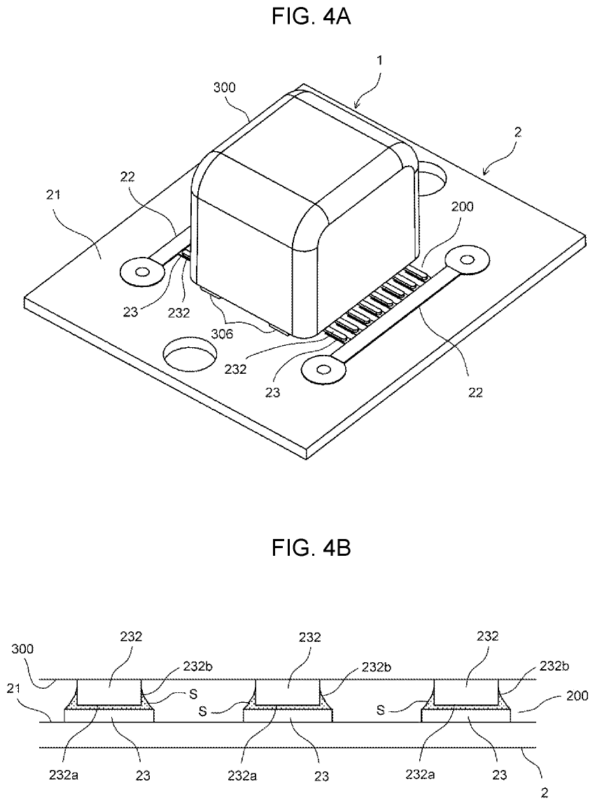

FIG. 4A is a perspective view showing how film capacitor 1 is surface-mounted on mounting surface 21 of printed circuit board 2. FIG. 4B is a diagram showing a part of connection terminal portions 232 and lands 23 connected by solder S.

As shown in FIG. 4A, a pair of conductive patterns 22 corresponding to the pair of bus bars 200 of film capacitor 1 is disposed on mounting surface 21 of printed circuit board 2. Eight lands 23 arranged in a comb-teeth shape are provided to each of conductive patterns 22.

When film capacitor 1 is mounted on mounting surface 21, first, solder paste (cream solder) is applied to eight lands 23. Next, film capacitor 1 is placed on mounting surface 21. Tips of connection terminal portions 232 protruding from case 300 are placed on the solder paste applied to lands 23. A height of each leg 306 of case 300 is set to a height that is a sum of thickness of each connection terminal portion 232 and thickness of each land 23, and four legs 306 of case 300 come into contact with mounting surface 21 to support film capacitor 1 with four legs 306.

Next, printed circuit board 2 on which film capacitor 1 is placed is heated upto a high temperature in a reflow furnace. At this time, since terminal portions connected to mounting surface 21 in each bus bar 200 are composed of eight (a plurality of) connection terminal portions 232 arranged in a comb-teeth shape, an entire surface area of eight connection terminal portions 232 become large compared to a case of a single terminal portion having the same volume. Hence, when heated in the reflow furnace, entire eight connection terminal portions 232 easily absorb heat, and eight connection terminal portions 232 quickly reach a high temperature. And the temperature of the solder paste reaches a melting high temperature, and the solder paste melts.

After that, when printed circuit board 2 is cooled, each connection terminal portion 232 and each land 23 are fixed with solder S. As shown in FIG. 4B, solder S spreads not only between lower surface 232a of connection terminal portion 232 and a surface of land 23 but also on side surfaces 232b at both sides of connection terminal portion 232, and side surfaces 232b and lands 23 are also joined with solder S.

At this time, as described above, the entire surface area of bus bar 200 of eight connection terminal portions 232 is larger than that of bus bar 200 having a single terminal portion (the entire surface area is increased by the area of fourteen side surfaces 232b). Hence, an area jointed by solder S increases. As a result, connection between eight connection terminal portions 232 and eight lands 23 is strengthened.

When film capacitor 1 is heated and cooled to be surface-mounted on printed circuit board 2, bus bars 200 and filling resin 400 around bus bars 200 thermally expand and thermally shrink. Since bus bars 200 and filling resin 400 have different coefficients of linear expansion, there is a concern that peeling may occur at interfaces of bus bars 200 and filling resin 400. In the present exemplary embodiment, since a portion of each bus bar 200 close to a surface of filling resin 400 is composed of eight intermediate terminal portions 231 arranged in a comb-teeth shape, a contact area with filling resin 400 becomes large. As a result, adhesion between bus bar 200 and filling resin 400 can be enhanced in a portion close to the surface of filling resin 400, so that peeling at interface portions due to thermal expansion and thermal shrinkage can be suppressed.

### Effects of Exemplary Embodiment

As described above, the present exemplary embodiment exerts the following effects.

Bus bar 200 includes the plurality of connection terminal portions 232 arranged in a comb-teeth shape. And the tips of the plurality of connection terminal portions 232 are placed on lands 23 provided on mounting surface 21 of printed circuit board 2 and connected to lands 23 by soldering. According to this configuration, when film capacitor 1 is heated to be surface-mounted on mounting surface 21 of printed circuit board 2, the plurality of connection terminal portions 232 are entirely quickly heated to a high temperature, and the solder paste quickly melts. As a result, capacitor element 100 is less likely to be exposed to a high temperature atmosphere for a long time, so that thermal damage is less likely to occur. Further, since the connection between the plurality of connection terminal portions 232 and corresponding lands 23 is strong, even if film capacitor 1 is used for a vehicle such as an automobile that easily receives vibration, connected portions are hard to peel off or break.

Further, bus bar 200 includes the plurality of intermediate terminal portions 231 which are arranged in a comb-teeth shape inside filling resin 400. The ends of the plurality of intermediate terminal portions 231 are exposed from filling resin 400, and are connected to respective connection terminal portions 232. According to this configuration, when film capacitor 1 is heated and cooled to be surface-mounted on printed circuit board 2, peeling between bus bar 200 and filling resin 400 is unlikely to occur in a portion close to the surface of filling resin 400. As a result, it is less likely that moisture invades inside filling resin 400 from a peeled portion, and it is less likely that moisture resistance is declined.

Further, the plurality of connection terminal portions 232 extends in the direction parallel to opening 300a of case 300 so as to protrude to the outside of case 300 in the direction. And the plurality of connection terminal portions 232 are respectively connected to lands 23 of mounting surface 21 in the protruding portions. According to this configuration, when film capacitor 1 is heated to be surface-mounted on mounting surface 21, heat given to the connected portions (protruding portions) of connection terminal portions 232 with lands 23 is not shielded by case 300. Therefore, the connected portions are effectively heated and tend to reach a high temperature quickly.

Further, case 300 has groove 308 extending in an insertion direction (up-down direction) in which capacitor element 100 is inserted into case 300. And groove 308 is formed on the inner wall surface of each of left side surface portion 304 and right side surface portion 305, which faces an end face of capacitor element 100. Bus bar 200 includes protrusion 212 and protruding piece 214 that are linearly arranged in the insertion direction and fit into groove 308. According to this configuration, it can be held that bus bar 200 is not tilted with respect to case 300. As a result, it can be held that eight connection terminal portions 232 arranged in the front-rear direction are parallel to the bottom surface of case 300, so that when film capacitor 1 is placed on mounting surface 21, eight connection terminal portions 232 are securely placed on eight lands 23.

Although the exemplary embodiment of the present disclosure has been described above, the present disclosure is not limited to the exemplary embodiment described above and application examples of the present disclosure can include various modifications in addition to the above exemplary embodiment.

### Modification 1

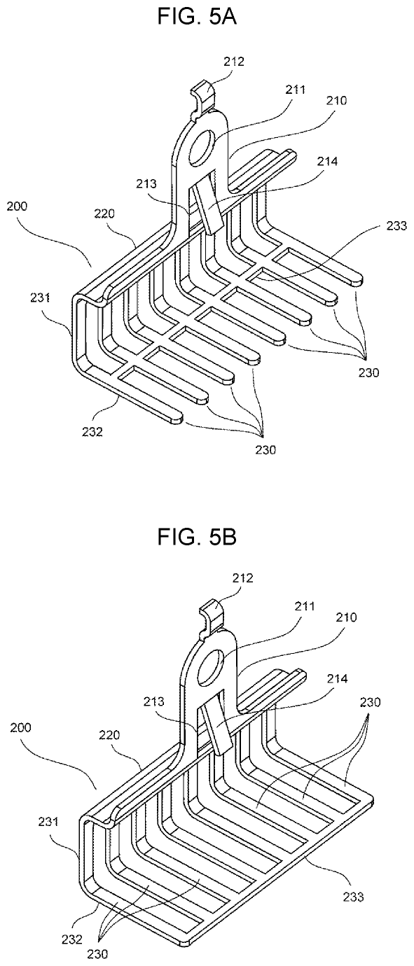

FIGS. 5A and 5B are perspective views illustrating bus bar 200 according to Modification 1.

In this modification, external connection terminal portions 230 of bus bar 200 includes connecting portion 233 that connects connection terminal portions 232 to each other in a direction in which eight connection terminal portions 232 are arranged. Connecting portion 233 may be formed at intermediate portions of connection terminal portions 232 as shown in FIG. 5A, or may be formed at tip portions of connection terminal portions 232 as shown in FIG. 5B. A width of connecting portion 233 is made smaller than a width of each connection terminal portion 232.

According to this modification, since the plurality of (eight) connection terminal portions 232 is reinforced in an arrangement direction of connection terminal portions 232, connection terminal portions 232 are less likely to be deformed even if something hits against connection terminal portions 232.

Further, since the width of connecting portion 233 is smaller than the width of each connection terminal portion 232, the heat capacity is unlikely to increase, and when film capacitor 1 is heated when being surface-mounted, heat absorption of the plurality of connection terminal portions 232 is unlikely to be prevented.

### Modification 2

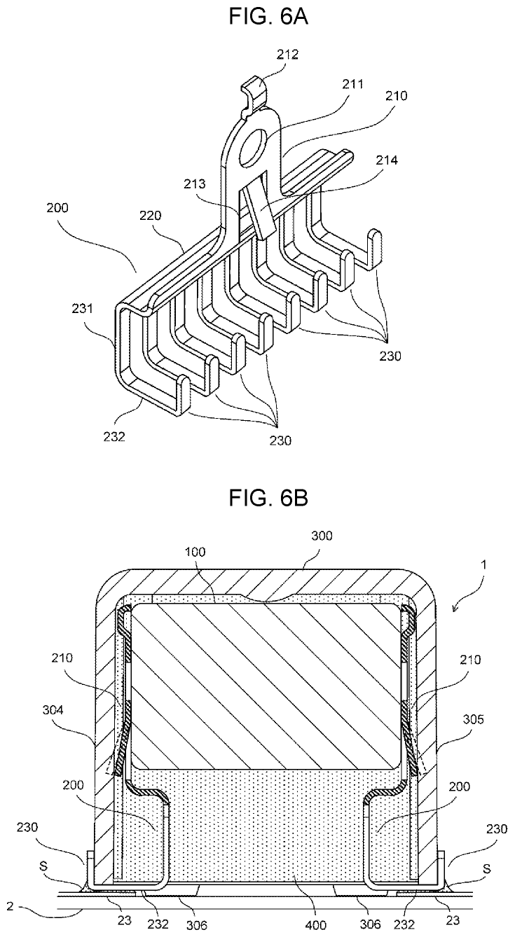

FIG. 6A is a perspective view illustrating bus bar 200 according to Modification 2, and FIG. 6B is a cross-sectional view of film capacitor 1 mounted on mounting surface 21 of printed circuit board 2 according to Modification 2.

In this modification, the tips of eight connection terminal portions 232 of bus bar 200 are bent upward. As shown in FIG. 6B, when film capacitor 1 is completed, the tips of eight connection terminal portions 232 of left bus bar 200 are in contact with the outer wall surface of left side surface portion 304 of case 300, and eight connection terminal portions 232 of right bus bar 200 are in contact with the outer wall surface of right side surface portion 305 of case 300.

As shown in FIG. 6B, in printed circuit board 2, eight lands 23 extend into inside case 300 and are connected to inner portions of the tips of eight connection terminal portions 232 by solder S.

### Other Modifications

In the above exemplary embodiment, bus bar 200 is configured such that external connection terminal portions 230 include a plurality of intermediate terminal portions 231 arranged in a comb-teeth shape. Meanwhile, bus bar 200 may be configured such that external connection terminal portions 230 do not include the plurality of intermediate terminal portions 231 and relay terminal portion 220 is extended downward to be connected to the plurality of connection terminal portions 232.

Further, in the above exemplary embodiment, lands 23 of mounting surface 21 are configured such that a part (tip portions) of connection terminal portions 232 of bus bar 200 are placed. Meanwhile, lands 23 may be configured such that the entire portions of connection terminal portions 232 are placed.

Moreover, in the above exemplary embodiment, single capacitor element 100 is used for film capacitor 1. Meanwhile, a plurality of capacitor elements 100 may be used for film capacitor 1.

Although capacitor element 100 of the above exemplary embodiment is made of metallized films in which aluminum is deposited on a dielectric film, capacitor element 100 may be made of metallized films in which another metal such as zinc or magnesium is deposited. Alternatively, capacitor element 100 may be made of metallized films in which a plurality of metals among such metals is deposited or be made of metallized films in which an alloy of such metals is deposited. Moreover, in the above exemplary embodiment, capacitor element 100 is formed through stacking of two metallized films in each of which aluminum is deposited on the dielectric film, and winding or laminating of the stacked metallized films. Alternatively, capacitor element 100 may be formed through stacking of an insulating film and a metallized film that includes a dielectric film and aluminum deposited on both sides of the dielectric film, and winding or laminating of the stacked insulating film and the metallized film.

Further, in the above exemplary embodiment, in film capacitor 1, capacitor element 100 is covered with filling resin 400, which is an exterior resin, and case 300. Meanwhile, film capacitor 1 may have a caseless configuration in which capacitor element 100 is covered only with the exterior resin.

Further, in the above exemplary embodiment, soldering is used to connect connection terminal portions 232 of bus bar 200 to lands 23 of mounting surface 21. Meanwhile, brazing other than soldering may be used.

Further, in the above exemplary embodiment, film capacitor 1 is used as an example of the capacitor of the present disclosure. Meanwhile, the present disclosure may be applied to capacitors other than film capacitor 1.

In addition, various modifications can be appropriately made to the exemplary embodiment of the present disclosure within the scope of the technical idea disclosed in the claims

It should be noted that, in the description of the above-described exemplary embodiment, a term indicating a direction, such as “upward” or “downward”, indicates a relative direction that only depends on a relative positional relationship of constituent members, and does not indicate an absolute direction, such as a vertical direction or a horizontal direction.

The present disclosure is useful for capacitors for use in various types of electronic devices, electrical devices, industrial equipment, electric components for vehicles, and the like.

What is claimed is:

1. A capacitor configured to be surface-mounted on a predetermined mounting surface, the capacitor comprising:
a capacitor element including an electrode at each of both end faces of the capacitor element; and
a bus bar connected to the electrode, wherein:
the bus bar includes a plurality of connection terminal portions that are arranged in a comb-teeth shape, and
at least one of the plurality of connection terminal portions is disposed on a connection portion disposed in the predetermined mounting surface and is electrically connected to the connection portion.

2. The capacitor according to claim 1, further comprising an exterior resin that covers the capacitor element, wherein:
the bus bar further includes an electrode terminal portion and a plurality of intermediate terminal portions, the electrode terminal portion being electrically connected to the electrode, the plurality of intermediate terminal portions being disposed between the electrode terminal portion and the plurality of connection terminal portions,
the plurality of intermediate terminal portions are arranged in a comb-teeth shape and are disposed in the exterior resin, and
a part of each of the plurality of intermediate terminal portions is connected to a corresponding connection terminal portion among the plurality of connection terminal portions, the part of the each of the plurality of intermediate terminal portions being exposed from the exterior resin.

3. The capacitor according to claim 1, further comprising a case that houses the capacitor element, wherein:
the case has an opening surface having an opening, the opening being configured to let the capacitor element pass through and be inserted into the case,
the plurality of connection terminal portions extends in a first direction parallel to the opening surface,
at least part of each of the plurality of connection terminal portions protrudes to an outside of the case in the first direction, and
the at least part of the each of the plurality of connection terminal portions is electrically connected to the connection portion.

4. The capacitor according to claim 1, further comprising a case that houses the capacitor element, wherein:
the case has an opening surface having an opening, the opening being configured to let the capacitor element pass through and be inserted into the case,
the case has a groove on an inner wall surface of the case that faces one of the both end faces of the capacitor element, the groove extending in an insertion direction along which the capacitor element is inserted into the case, and
the bus bar has a first protrusion and a second protrusion each of which fits in the groove, and the first protrusion and the second protrusion are aligned along the insertion direction.

5. The capacitor according to claim 1, wherein the bus bar further includes a connecting portion that connects the plurality of connection terminal portions to each other, the connecting portion extending in a direction along which the plurality of connection terminal portions are arranged.
